(19) United States
(12) Patent Application Publication
(10) Pub. No.: US 2013/0249995 A1
(43) Pub. Date: Sep. 26, 2013

(54) COATING APPARATUS AND INKJET RECORDING APPARATUS

(71) Applicant: FUJIFILM CORPORATION, Tokyo (JP)

(72) Inventors: Gentaro FURUKAWA, Kanagawa (JP); Hiroshi UEMURA, Kanagawa (JP)

(73) Assignee: FUJIFILM CORPORATION, Tokyo (JP)

(21) Appl. No.: 13/848,606

(22) Filed: Mar. 21, 2013

(30) Foreign Application Priority Data
Mar. 23, 2012 (JP) 2012-066981

(51) Int. Cl. B05C 1/08; B41J 2/01

(52) U.S. Cl. CPC B05C 1/0834; B41J 2/01
USPC 347/21; 118/262; 118/255

(57) ABSTRACT

A coating apparatus includes: a coating roller configured to apply a coating liquid to an object to be coated; a supply roller configured to supply the coating liquid to the coating roller, wherein: the supply roller has a circumferential surface of which a width is larger than a width of a circumferential surface of the coating roller, the circumferential surface of the supply roller has a contact region configured to make contact with the coating roller and non-contact regions configured not to make contact with the coating roller, the contact region has a surface state different from a surface state of the non-contact regions such that a flow velocity of the coating liquid flowing on the non-contact regions is faster than a flow velocity of the coating liquid flowing on the contact region; and a coating liquid supply device configured to supply the coating liquid to the supply roller.

### BACKGROUND OF THE INVENTION

1. Field of the Invention

The present invention relates to a coating apparatus, and more particularly to a coating apparatus which is incorporated in an inkjet recording apparatus and coats paper with a prescribed treatment liquid.

2. Description of the Related Art

An inkjet recording apparatus is known which can be used with generic printing paper (general paper used in general offset printing, and the like (namely, paper having cellulose as a main component, such as top grade paper, coated paper, art paper, etc.), rather than special inkjet paper) by coating the paper with a prescribed treatment liquid before printing. An inkjet recording apparatus of this kind is provided with a coating apparatus which applies the prescribed treatment liquid to the paper before printing.

The coating apparatus can use various methods, such as a method of applying the liquid by spraying (spray application method), a method of applying the liquid using an inkjet head (inkjet application method), and the like, and a method of applying the liquid by using a coating roller (roller application method) is relatively common.

In general, with the roller application method, a supply roller takes up a treatment liquid stored in a coating liquid receptacle, and supplies the treatment liquid to the coating roller. However, with this method, the treatment liquid collects in the form of rings in both end portions of each roller, and can be scattered by the rotation of the rollers or can drip from the rollers.

Therefore, Japanese Patent Application Publication No. 2011-062831 proposes that a supply roller is formed to have the width greater than the width of a coating roller, and furthermore, the coating liquid receptacle is formed to extend to both end portions of the coating roller, thereby preventing the treatment liquid from scattering and dripping.

However, the composition of Japanese Patent Application Publication No. 2011-062831 has a drawback in that, although scattering and dripping of the treatment liquid from the supply roller can be prevented, scattering and dripping of the treatment liquid from the coating roller cannot be prevented. That is, collections of the treatment liquid also occur on the coating roller, as well as the supply roller, but since the coating liquid receptacle is not disposed below either end of the coating roller, then there is a drawback in that scattering and dripping of the treatment liquid which occur from the coating roller cannot be captured in the coating liquid receptacle.

Furthermore, generally, the ring-shaped collections of the liquid which occur in both end portions of the coating roller become especially marked when the supply roller is rotated continuously, or when the supply roller is rotated at high speed. Then, the composition described in Japanese Patent Application Publication No. 2011-062831 also has a drawback in not being able to respond to cases where the processing is carried out continuously over a long period of time, or where the processing is carried out at high speed.

### SUMMARY OF THE INVENTION

The present invention has been contrived in view of these circumstances, an object thereof being to provide a coating apparatus and an inkjet recording apparatus which are capable of preventing the occurrence of collections of liquid in both end portions of a coating roller.

In order to attain the aforementioned object, the present invention is directed to a coating apparatus, comprising: a coating roller which is configured to apply a coating liquid to an object to be coated; a supply roller which is configured to abut on the coating roller and supply the coating liquid to the coating roller, wherein: the supply roller has a circumferential surface of which a width is larger than a width of a circumferential surface of the coating roller, the circumferential surface of the supply roller has a contact region configured to make contact with the coating roller and non-contact regions configured not to make contact with the coating roller, the non-contact regions are arranged respectively in both end portions of the circumferential surface of the supply roller in a widthwise direction thereof, the contact region has a surface state different from a surface state of each of the non-contact regions such that a flow velocity of the coating liquid flowing on each of the non-contact regions is faster than a flow velocity of the coating liquid flowing on the contact region; and a coating liquid supply device which is configured to supply the coating liquid to the supply roller.

According to this aspect of the present invention, the width of the circumferential surface of the supply roller is formed to be larger than the width of the circumferential surface of the coating roller, so as to form the non-contact regions that do not make contact with the coating roller in both end portions of the circumferential surface of the supply roller. The supply roller is formed to differentiate the surface state between the contact region which makes contact with the coating roller and the non-contact regions which do not make contact with the coating roller, in such a manner that the flow velocity of the coating liquid flowing on the non-contact regions is faster than the flow velocity of the coating liquid flowing on the contact region. More specifically, the coating liquid is made to flow more readily on the non-contact regions than on the contact region. Thus, it is possible to prevent the occurrence of ring-shaped collections of the coating liquid at both ends of the coating roller, and scattering of the coating liquid from the coating roller and the occurrence of dripping of the coating liquid can be prevented.

Surface tension acts on the coating liquid so as to reduce the surface area thereof. In the contact region, a film of the coating liquid is formed between the coating roller and the supply roller, and therefore a force causing the coating liquid to flow in the axial direction is obtained due to the surface tension when the volume of the coating liquid increases. On the other hand, in the non-contact regions, the coating roller is not present and therefore the force moving the coating liquid in the axial direction does not exist. As a result of this, the flow of the coating liquid stagnates in the end portions of the coating roller and ring-shaped collections of the coating liquid occur in the end portions of the coating roller. By making the coating liquid flow more readily in the non-contact regions, as in the present invention, it is possible to suppress the occurrence of collections of the coating liquid in the end portions of the coating roller and the occurrence of ring-shaped collections of the coating liquid can be prevented in the end portions of the coating roller. Furthermore, since the occurrence of collections of the coating liquid can be prevented even when the coating roller is rotated at high speed, then it is possible to increase the speed of the coating process.

In order to attain the aforementioned object, the present invention is also directed to a coating apparatus, comprising: a coating roller which is configured to apply a coating liquid to an object to be coated; multi-stage supply rollers which are arranged to sequentially abut to each other, wherein: a final one of the supply rollers which is at a final stage of the multi-stage supply rollers is configured to abut on the coating roller and supply the coating liquid to the coating roller, the final one of the supply rollers has a circumferential surface of which a width is larger than a width of a circumferential surface of the coating roller, the circumferential surface of the final one of the supply rollers has a contact region configured to make contact with the coating roller and non-contact regions configured not to make contact with the coating roller, and the non-contact regions are arranged respectively in both end portions of the circumferential surface of the final one of the supply rollers in a widthwise direction thereof, in each pair of the supply rollers constituted of a first one of the pair and a second one of the pair which abuts on the first one of the pair and is nearer to the coating roller than the first one of the pair, the first one of the pair has a circumferential surface of which a width is larger than a width of a circumferential surface of the second one of the pair, the circumferential surface of the first one of the pair has a contact region configured to make contact with the second one of the pair and non-contact regions configured not to make contact with the second one of the pair, and the non-contact regions are arranged respectively in both end portions of the circumferential surface of the first one of the pair in a widthwise direction thereof, and in each of the supply rollers, the contact region has a surface state different from a surface state of each of the non-contact regions such that a flow velocity of the coating liquid flowing on each of the non-contact regions is faster than a flow velocity of the coating liquid flowing on the contact region; and a coating liquid supply device which is configured to supply the coating liquid to an initial one of the supply rollers which is at an initial stage of the multi-stage supply rollers.

According to this aspect of the present invention, the coating liquid is supplied to the coating roller by the multi-stage supply rollers constituted of the plurality of supply rollers. The supply rollers constituting the multi-stage supply rollers are formed in such a manner that, in each pair of the supply rollers, the width of the circumferential surface of a first one of the pair of the supply rollers at a preceding stage is larger than the width of the circumferential surface of a second one of the pair of the supply rollers at a subsequent stage, and there are the regions which are not contact with the second supply roller at the subsequent stage in both end portions in the widthwise direction of the circumferential surface of the first supply roller at the preceding stage. Furthermore, the circumferential surface of a final one of the supply rollers at the final stage is formed to have the width larger than the width of the circumferential surface of the coating roller, and there are the regions which do not make contact with the coating roller in both end portions in the widthwise direction of the circumferential surface of the supply roller at the final stage. Each of the supply rollers is formed by differentiating the surface state between the contact region and the non-contact regions, in such a manner that the flow velocity of the coating liquid flowing on the non-contact regions is faster than the flow velocity of the coating liquid flowing on the contact region. Consequently, it is possible to prevent the occurrence of ring-shaped collections of the coating liquid at both ends of each of the coating roller and the supply rollers.

Preferably, the surface state of the contact region is different from the surface state of each of the non-contact regions such that a contact angle of the coating liquid to each of the non-contact regions is smaller than a contact angle of the coating liquid to the contact region.

According to this aspect of the present invention, the surface state of each of the non-contact regions is differentiated from the surface state of the contact region such that the contact angle of the coating liquid to each of the non-contact regions is smaller than the contact angle of the coating liquid to the contact region. In other words, the hydrophilic properties of the non-contact regions are increased compared to the contact region. Thereby, the flow velocity of the coating liquid flowing on the non-contact regions is made faster than the flow velocity of the coating liquid flowing on the contact region, and the coating liquid can be made to flow more readily on the non-contact regions than on the contact region.

Preferably, a material constituting the contact region is different from a material constituting each of the non-contact regions such that the contact angle of the coating liquid to each of the non-contact regions is smaller than the contact angle of the coating liquid to the contact region.

According to this aspect of the present invention, the material which constitutes the contact region and the material which constitutes the non-contact regions are differentiated in such a manner that the contact angle of the coating liquid to the non-contact regions is smaller than the contact angle of the coating liquid to the contact region. Thereby, the flow velocity of the coating liquid flowing on the non-contact regions is made faster than the flow velocity of the coating liquid flowing on the contact region, and the coating liquid can be made to flow more readily on the non-contact regions. For example, when the supply roller is made of rubber material, then the contact region is made from rubber having high hydrophobic properties (for example, fluoric rubber), and the non-contact regions are made from rubber having high hydrophilic properties (for example, nitrile butadiene rubber (NBR)). For example, when the supply roller is made from a metal material, then the contact region is made from a metal having hydrophobic properties (for example, aluminum, stainless steel, or the like), and the non-contact regions are made from a metal having hydrophilic properties (for example, titanium, or the like). Consequently, it is possible to make the contact angle of the coating liquid to the non-contact regions smaller than the contact angle of the coating liquid to the contact region. In other words, it is possible to increase the hydrophilic properties of the non-contact regions compared to the contact region.

Preferably, the contact region is made from a hydrophobic material and each of the non-contact regions is made from a hydrophilic material.

According to this aspect of the present invention, the contact region is made from the material having hydrophobic properties and the non-contact regions are made from the material having hydrophilic properties. For example, as described above, when the supply roller is made of rubber material, then the contact region is made from rubber having high hydrophobic properties (for example, fluoric rubber), and the non-contact regions are made from rubber having high hydrophilic properties (for example, NBR). For example, when the supply roller is made from the metal material, then the contact region is made from a metal having hydrophobic properties (for example, aluminum, stainless steel, or the like), and the non-contact regions are made from a metal having hydrophilic properties (for example, titanium, or the like). Consequently, it is possible to make the contact angle of the coating liquid to the non-contact regions smaller than the contact angle of the coating liquid to the contact region. In other words, it is possible to increase the hydrophilic properties of the non-contact regions compared to the contact region.

It is also preferable that at least one of the contact region and each of the non-contact regions is coated with a thin film such that the contact angle of the coating liquid to each of the non-contact regions is smaller than the contact angle of the coating liquid to the contact region.

According to this aspect of the present invention, at least one of the contact region and the non-contact regions are coated with a thin film in such a manner that the contact angle of the coating liquid to the non-contact regions is smaller than the contact angle of the coating liquid to the contact region. For example, the contact region is coated with a hydrophobic film of PTFE (polytetrafluoroethylene (tetrafluoride)), PFA (tetrafluoroethylene-perfluoroalkylvinylether copolymer polytetrafluoroethylene), or the like. Furthermore, the non-contact regions are coated with a hydrophilic film of silica particles, or the like. Consequently, it is possible to make the contact angle of the coating liquid to the non-contact regions smaller than the contact angle of the coating liquid to the contact region. In other words, it is possible to increase the hydrophilic properties of the non-contact regions compared to the contact region.

Preferably, the contact region is coated with a hydrophobic film and each of the non-contact regions are coated with a hydrophilic film.

According to this aspect of the present invention, the contact region is coated with the hydrophobic film and the non-contact regions are coated with the hydrophilic film. For example, as described above, the contact region is coated with the hydrophobic film, such as PTFE, PFA, or the like, and the non-contact regions are coated with the hydrophilic film of silica particles, or the like. Consequently, it is possible to make the contact angle of the coating liquid to the non-contact regions smaller than the contact angle of the coating liquid to the contact region.

It is also preferable that a surface roughness of the contact region is different from a surface roughness of each of the non-contact regions such that the contact angle of the coating liquid to each of the non-contact regions is smaller than the contact angle of the coating liquid to the contact region.

According to this aspect of the present invention, the surface roughness of the contact region and the surface roughness of the non-contact regions are differentiated in such a manner that the contact angle of the coating liquid to the non-contact regions is smaller than the contact angle of the coating liquid to the contact region. In other words, the value of the surface roughness of the non-contact regions is made greater than the contact region. Consequently, it is possible to make the contact angle of the coating liquid to the non-contact regions smaller than the contact angle of the coating liquid to the contact region. In other words, it is possible to increase the hydrophilic properties of the non-contact regions compared to the contact region.

Preferably, each of the non-contact regions has grooves which are arranged in a uniform pitch in a circumferential direction of the supply roller and are parallel to an axis of the supply roller.

According to this aspect of the present invention, the grooves parallel to the axis of the supply roller are formed at the uniform pitch in the circumferential direction, in the non-contact regions. Hence, a force causing the coating liquid to flow along the grooves acts due to the effects of the surface tension, and the flow velocity of the coating liquid flowing on the non-contact regions can be made faster than the flow velocity of the coating liquid flowing on the contact region. In other words, the coating liquid can be made to flow more readily in the axial direction, in the non-contact regions. Therefore, it is possible to prevent the occurrence of ring-shaped collections of the coating liquid at both ends of the coating roller, and scattering of the coating liquid from the coating roller and the occurrence of dripping of the coating liquid can be prevented.

Preferably, the supply roller has flange sections in both ends thereof.

According to this aspect of the present invention, the flange sections are arranged at both ends of the supply roller. In other words, a return portion is formed in each end portion of the supply roller. Thus, it is possible to prevent the coating liquid from adhering to the edges of the supply roller and scattering in the axial direction.

In order to attain the aforementioned object, the present invention is also directed to an inkjet recording apparatus, comprising: the coating apparatus as defined in claim 1 which is configured to apply a prescribed coating liquid to a surface of paper; and an inkjet head which is configured to form an image by ejecting and depositing ink droplets onto the surface of the paper that has been coated with the coating liquid.

According to this aspect of the present invention, the prescribed coating liquid is applied to the paper before printing, by the coating apparatus according to the present invention described above. An image is recorded on the paper by ejecting and deposing ink droplets from the inkjet head onto the paper which has been coated with the coating liquid by the coating apparatus. Since the coating apparatus does not scatter the coating liquid, it is possible to carry out the coating process without soiling the peripheral area. Furthermore, since the coating process can be performed at high speed, then compatibility with high-speed printing can be achieved.

According to the present invention, it is possible to prevent the occurrence of collections of the coating liquid in both end portions of the coating roller. Consequently, scattering or dripping of the coating liquid from the coating roller can be prevented. Furthermore, even when the coating roller is rotated at high speed, it is possible to prevent scattering and dripping of the coating liquid from the coating roller, and therefore it is possible to increase the speed of the coating process.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus including a coating apparatus;

FIG. 2 is a block diagram showing the schematic composition of a control system of the inkjet recording apparatus;

FIG. 3 is a side view diagram showing the schematic composition of the coating apparatus;

FIG. 4 is a plan diagram showing the schematic composition of the coating apparatus;

FIG. 5 is a perspective diagram showing the schematic composition of the coating apparatus;

FIG. 6 is a perspective diagram showing the schematic composition of a modification of the coating apparatus;

FIG. 7 is a perspective diagram showing the schematic composition of the modification of the coating apparatus;

FIG. 8 is a side view diagram showing the schematic composition of a coating apparatus of a type which supplies treatment liquid to a coating roller through two supply rollers (two-stage supply rollers); and

FIG. 9 is a plan diagram showing the schematic composition of the coating apparatus shown in FIG. 8.

### DETAILED DESCRIPTION OF THE PREFERRED EMBODIMENTS

### General Composition of Inkjet Recording Apparatus

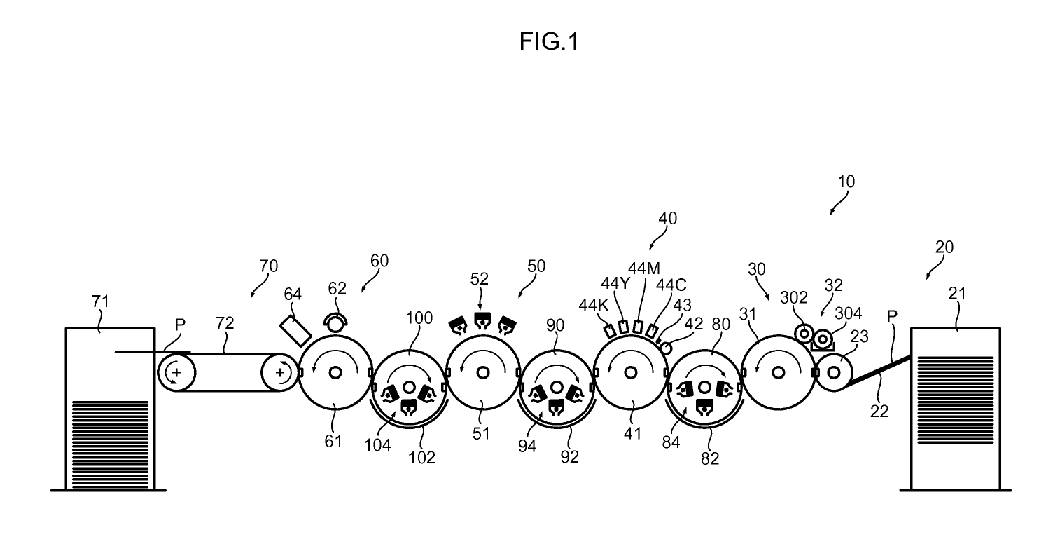

FIG. 1 is a general schematic drawing of an inkjet recording apparatus including a coating apparatus.

The inkjet recording apparatus 10 is configured to record an image by an inkjet method on generic printing paper (cut sheets of paper) using aqueous ink (ink containing water as solvent). When an image is recorded by the inkjet method using the aqueous ink on the generic printing paper without any treatment, it is not possible to record the image of high quality due to the occurrence of feathering, bleeding, and the like. Therefore, in the inkjet recording apparatus of this kind, the image recording is carried out after coating the paper with a prescribed treatment liquid. More specifically, the image recording is carried out after applying a liquid having a function of aggregating a coloring material component in the ink, onto the paper. The inkjet recording apparatus is provided with the coating apparatus for this purpose. The composition of the inkjet recording apparatus 10 according to the present embodiment is described in detail below.

As shown in FIG. 1, the inkjet recording apparatus 10 in the present embodiment includes: a paper supply unit 20, which carries out a supply process of sheets of paper P; a treatment liquid application unit 30, which carries out a treatment liquid application process; an image recording unit 40, which carries out an image recording process; an ink drying unit 50, which carries out a drying process; a fixing unit 60, which carries out an image fixing process; and a recovery unit 70, which carries out a recovery process of the sheets of paper P.

The treatment liquid application unit 30, the image recording unit 40, the ink drying unit 50 and the fixing unit 60 are provided with conveyance drums 31, 41, 51 and 61, respectively, as conveyance devices for the sheets of paper P. The sheets of paper P are conveyed through the treatment liquid application unit 30, the image recording unit 40, the ink drying unit 50 and the fixing unit 60, by means of the conveyance drums 31, 41, 51 and 61.

Each of the conveyance drums 31, 41, 51 and 61 is formed in a cylindrical shape, which corresponds to the width of the sheet of paper P, and rotates by being driven by a motor (not shown) (in FIG. 1, the conveyance drums 31, 41, 51 and 61 rotate in the counter-clockwise direction). Each of the conveyance drums 31, 41, 51 and 61 is provided with grippers disposed on the circumferential surface thereof. The sheet of paper P is conveyed with the leading end portion thereof being gripped by the gripper. In the present embodiment, each of the conveyance drums 31, 41, 51 and 61 has the grippers disposed in two locations on the circumferential surface thereof, and it is thereby possible to convey two sheets of paper P in one revolution.

The circumferential surface of each of the conveyance drums 31, 41, 51 and 61 is formed with a plurality of suction holes. The sheet of paper P is held on the outer circumferential surface of each of the conveyance drums 31, 41, 51 and 61, due to the rear surface of the sheet of paper P being vacuum suctioned through the suction holes. In the present embodiment, the sheets of paper P are held by vacuum suction; however, it is also possible to adopt a composition which holds the sheets of paper P by electrostatic attraction.

Transfer drums 80, 90 and 100 are disposed respectively between the treatment liquid application unit 30 and the image recording unit 40, between the image recording unit 40 and the ink drying unit 50, and between the ink drying unit 50 and the fixing unit 60. The sheets of paper P are conveyed between the respective units by means of the transfer drums 80, 90 and 100.

Each of the transfer drums 80, 90 and 100 is composed as a cylindrical frame, which corresponds to the width of the sheet of paper P, and rotates by being driven by a motor (not shown) (in FIG. 1, the transfer drums 80, 90 and 100 rotate in the clockwise direction). Each of the transfer drums 80, 90 and 100 is provided with grippers disposed on the circumferential surface thereof. The sheet of paper P is conveyed with the leading end portion thereof being gripped by the gripper. In the present embodiment, each of the transfer drums 80, 90 and 100 has the grippers disposed in two locations on the circumferential surface thereof, and it is thereby possible to convey two sheets of paper P in one revolution.

Circular arc-shaped guide plates 82, 92 and 102 are disposed along the conveyance path of the sheets of paper P, below the transfer drums 80, 90 and 100, respectively. The sheets of paper P which are conveyed by the transfer drums 80, 90 and 100 are conveyed while the rear surfaces of the sheets of paper P (the surfaces reverse to the printing surfaces) are guided by the guide plates 82, 92 and 102.

The transfer drums 80, 90 and 100 are provided with driers 84, 94 and 104, which are disposed inside the transfer drums 80, 90 and 100 and blow warm air flows toward the sheets of paper P conveyed by the transfer drums 80, 90 and 100, respectively (in the present embodiment, three driers are disposed along the conveyance path of the sheets of paper P). The warm air flows blown out from the driers 84, 94 and 104 during the conveyance process strike the printing surfaces of the sheets of paper P conveyed by the transfer drums 80, 90 and 100.

The driers 84, 94 and 104 can be composed so as to heat the sheets of paper P by radiating heat from infrared heaters, or the like, (so-called heating by radiation), rather than the composition where the sheets of paper P are heated by being blown with the warm air flows.

The sheets of paper P supplied from the paper supply unit 20 are conveyed successively to the conveyance drum 31, the transfer drum 80, the conveyance drum 41, the transfer drum 90, the conveyance drum 51, the transfer drum 100 and the conveyance drum 61, and are finally recovered by the recovery unit 70. From the supply at the paper supply unit 20 until the recovery at the recovery unit 70, the sheets of paper P are subjected to prescribed processing and images are recorded on the printing surfaces of the sheets of paper P.

The compositions of the respective units of the inkjet recording apparatus 10 according to the present embodiment are described in detail below.

### <Paper Supply Unit>

The paper supply unit 20 carries out the paper supply process of the sheets of paper P. In particular, the inkjet recording apparatus 10 in the present embodiment successively supplies the cut sheets of paper P, one sheet at a time. The paper supply unit 20 includes a paper supply device 21, a paper supply tray 22 and a transfer drum 23.

The paper supply device 21 supplies the sheets of paper P stacked in a magazine (not shown), one sheet at a time from the upper side, successively to the paper supply tray 22.

The paper supply tray 22 outputs the sheet of paper P supplied from the paper supply apparatus 21, to the transfer drum 23.

The transfer drum 23 receives the sheet of paper P output from the paper supply tray 22, and rotates so as to transfer the sheet of paper P to the conveyance drum 31 of the treatment liquid application unit 30.

As described above, when an image is recorded by the inkjet method using the aqueous ink on a generic printing paper with no treatment, it is not possible to record an image of high quality due to the occurrence of feathering, bleeding, and the like. Therefore, in order to prevent these problems, the prescribed treatment liquid is applied to the sheet of paper P by the treatment liquid application unit 30, which is described below.

### <Treatment Liquid Application Unit>

The treatment liquid application unit 30 applies the prescribed treatment liquid to the printing surface of the sheet of paper P (an object to be coated) P. The treatment liquid application unit 30 includes: a conveyance drum (hereinafter referred to as the “treatment liquid application drum”) 31, which conveys the sheet of paper P; and a coating apparatus 32, which coats the printing surface of the sheet of paper P conveyed by the treatment liquid application drum 31 with the prescribed treatment liquid.

The treatment liquid application drum 31 receives the sheet of paper P from the transfer drum 23 of the paper supply unit 20 (by gripping the leading end of the sheet of paper P with the gripper), and conveys the sheet of paper P along a prescribed conveyance path by rotating.

The coating apparatus 32 applies the prescribed treatment liquid by means of a roller to the printing surface of the sheet of paper P which is conveyed by the treatment liquid application drum 31. The composition of the coating apparatus 32 is described in detail later.

The treatment liquid applied by the coating apparatus 32 is constituted of a liquid which contains an aggregating agent that aggregates components in the ink composition.

The aggregating agent used can be a compound capable of changing the pH of the ink composition, or a multivalent metal salt, or a polyallyl amine.

Desirable examples of the compound capable of lowering the pH of the ink composition are acidic substances having high water solubility (such as phosphoric acid, nitric acid, malonic acid, citric acid, or derivatives or salts of these compounds, or the like). It is possible to use either one type only, or a combination of two or more types, of the acid substances. By this means, the aggregating properties are raised and the whole of the ink can be solidified.

Moreover, it is desirable that the pH (at 25° C.) of the ink composition is not less than 8.0, and the pH (at 25° C.) of the treatment liquid is in the range of 0.5 to 4. Consequently, it is possible to achieve good image density and resolution and high speed inkjet recording.

It is possible to include additives in the treatment liquid. For example, the treatment liquid can contain commonly known additives, such as an anti-drying agent (humectant agent), an anti-fading agent, an emulsion stabilizer, a permeation promoter, an ultraviolet light absorber, an antibacterial agent, an antiseptic agent, a pH adjuster, a surface tension adjuster, an antifoaming agent, a viscosity adjuster, a dispersant, a dispersion stabilizer, an anti-rusting agent, a chelating agent, or the like.

By applying a treatment liquid of this kind to the printing surface of the sheet of paper P in advance of printing, the occurrence of feathering and bleeding, or the like, can be prevented, and printing of high quality can be performed, even if using general printing paper.

In the treatment liquid application unit 30 having the composition described above, the sheet of paper P is held on the treatment liquid application drum 31 and is conveyed along the prescribed conveyance path. During this conveyance process, the printing surface of the sheet of paper P is coated with the treatment liquid by the coating apparatus 32.

The sheet of paper P of which the printing surface has been coated with the treatment liquid is then transferred from the treatment liquid application drum 31 onto the transfer drum 80 at a prescribed position. Thereupon, the sheet of paper P is conveyed along the prescribed conveyance path by the transfer drum 80 and is transferred onto the conveyance drum 41 of the image recording unit 40.

As described above, the drier 84 is disposed inside the transfer drum 80 and blows a warm air flow toward the guide plate 82. The warm air flow is blown onto the printing surface of the sheet of paper P during the conveyance process from the treatment liquid application unit 30 to the image recording unit 40 by the transfer drum 80, and thereby the treatment liquid that has been applied to the printing surface of the sheet of paper P is dried (i.e., the solvent component in the treatment liquid is evaporated).

### <Image Recording Unit>

The image recording unit 40 forms a color image on the printing surface of the sheet of paper P by ejecting and depositing droplets of inks of colors of cyan (C), magenta (M), yellow (Y) and black (K) onto the printing surface of the sheet of paper P. The image recording unit 40 includes: a conveyance drum (hereinafter referred to as the “image recording drum”) 41, which conveys the sheet of paper P; a paper pressing roller 42, which presses the printing surface of the sheet of paper P and causes the rear surface of the sheet of paper P to make tight contact with the outer circumferential surface of the image recording drum 41; a paper floating detection sensor 43, which detects floating of the sheet of paper P; and inkjet heads 44C, 44M, 44Y and 44K, which form an image by ejecting and depositing ink droplets of the respective colors of C, M, Y and K onto the printing surface of the sheet of paper P.

The image recording drum 41 receives the sheet of paper P from the transfer drum 80 (by gripping the leading end of the sheet of paper P with the gripper), and conveys the sheet of paper P along a prescribed conveyance path by rotating.

The paper pressing roller 42 is constituted of a rubber roller, which corresponds to the width of the sheet of paper P, and is disposed in the vicinity of the paper receiving position of the image recording drum 41 (the position where the sheet of paper P is received from the transfer drum 80). The sheet of paper P transferred from the transfer drum 80 onto the image recording drum 41 is nipped by the paper pressing roller 42, thereby causing the rear surface of the sheet of paper P to make tight contact with the outer circumferential surface of the image recording drum 41.

The paper floating detection sensor 43 detects floating of the sheet of paper P passing the paper pressing roller 42 (a prescribed amount of floating or more from the outer circumferential surface of the image recording drum 41). The paper floating detection sensor 43 is constituted of a laser emitter and a laser receiver, for example. The laser emitter emits laser light parallel to the axis of the image recording drum 41, from one end of the image recording drum 41 toward the other end thereof, at a position a prescribed height above the outer circumferential surface of the image recording drum 41. The laser receiver is disposed so as to oppose the laser emitter on the other end of the image recording drum 41, and receives the laser light emitted by the laser emitter. If floating of the sheet of paper P occurs to a certain extent or more as the sheet of paper P passes the paper pressing roller 42, then the laser light emitted from the laser emitter is obstructed by the sheet of paper P and cannot be received by the laser receiver. The paper floating detection sensor 43 detects the floating of the sheet of paper P by determining the presence or absence of the received laser light in the laser receiver.

The four inkjet heads 44C, 44M, 44Y and 44K are disposed after the paper floating detection sensor 43 and are disposed at uniform intervals along the conveyance path of the sheet of paper P. The inkjet heads 44C, 44M, 44Y and 44K are constituted of line heads, which correspond to the width of the sheet of paper P. Each of the inkjet heads 44C, 44M, 44Y and 44K ejects droplets of the ink of the corresponding color toward the image recording drum 41, from a row of nozzles formed in a nozzle surface thereof.

The ink used in the inkjet recording apparatus 10 according to the present embodiment is an aqueous ultraviolet-curable ink, which contains a pigment, polymer particles and a water-soluble polymerizable compound which can be polymerized by an active energy beam. The aqueous ultraviolet-curable ink can be cured by being irradiated with ultraviolet light, and has properties such as excellent weatherproofing and high film strength.

The pigment used is a water-dispersible pigment in which at least a portion of the surface of each pigment particle is coated with a polymer dispersant.

The polymer dispersant employs a polymer dispersant having an acid value of 25 to 1000 (KOH mg/g). In this case, self-dispersion stability is good and aggregating properties upon contact with the treatment liquid are good.

The polymer particles use self-dispersing polymer particles having an acid value of 20 to 50 (KOH mg/g). In this case, self-dispersion stability is good and aggregating properties upon contact with the treatment liquid are good.

It is desirable that the polymerizable compound is an anionic or cationic polymerizable compound from the viewpoint of not disturbing the reaction between the aggregating agent, the pigment and the polymer particles, and has a solubility of not less than 10 wt % (and more desirably, not less than 15 wt %) with respect to water

The ink contains a polymerization initiator which starts polymerization of the polymerizable compound by the active energy beam. The initiator can include a suitably selected compound which is capable of starting the polymerization reaction upon irradiation with the active energy beam; for example, it is possible to use an initiator (for example, a photopolymerization initiator) which creates active species (radical, acid, base, or the like) upon irradiation with a beam of radiation, light or an electron beam. The polymerization initiator can also be contained in the treatment liquid, and it is sufficient that the polymerization initiator is contained in at least one of the ink and the treatment liquid.

Moreover, the ink contains 50 to 70 wt % of water. Further, it is possible to include additives in the ink. For example, the ink can contain commonly known additives, such as a water-soluble organic solvent or an anti-drying agent (humectant agent), an anti-fading agent, an emulsion stabilizer, a permeation promoter, an ultraviolet light absorber, an antibacterial agent, an antiseptic agent, a pH adjuster, a surface tension adjuster, an antifoaming agent, a viscosity adjuster, a dispersant, a dispersion stabilizer, an anti-rusting agent, a chelating agent, or the like.

In the image recording unit 40 having the composition described above, the sheet of paper P is conveyed along the prescribed conveyance path by the image recording drum 41. The sheet of paper P transferred from the transfer drum 80 onto the image recording drum 41 is firstly nipped by the paper pressing roller 42, and is thereby caused to make tight contact with the outer circumferential surface of the image recording drum 41. Thereupon, the presence or absence of floating is determined by the paper floating detection sensor 43, whereupon ink droplets of the colors of C, M, Y and K are ejected and deposited onto the printing surface of the sheet of paper P from the respective inkjet heads 44C, 44M, 44Y and 44K, thereby forming a color image on the printing surface of the sheet of paper P.

When the paper floating detection sensor 43 detects the sheet of paper P floating from the outer circumferential surface of the image recording drum 41, the conveyance of the sheet of paper P is halted. Thus, the floating sheet of paper P can be prevented from making contact to the nozzle surfaces of the inkjet heads 44C, 44M, 44Y and 44K.

As described above, in the inkjet recording apparatus 10 according to the present embodiment, the aqueous ink is used for each of the colors. Even if using the aqueous ink of this kind, since the printing surface of the sheet of paper P has been coated with the treatment liquid as described above, then it is possible to carry out printing of high quality even if using generic printing paper.

The sheet of paper P on which the image has been printed is transferred from the image recording drum 41 onto the transfer drum 90. Thereupon, the sheet of paper P is conveyed along the prescribed conveyance path by the transfer drum 90 and is transferred onto the conveyance drum 51 of the image drying unit 50.

As described above, the drier 94 is disposed inside the transfer drum 90 and blows a warm air flow toward the guide plate 92. The sheet of paper P thereby undergoes a drying process during the conveyance by the transfer drum 90, although an ink drying process is carried out in the ink drying unit 50 at a later stage.

Although not shown in the drawings, the image recording unit 40 is provided with a maintenance unit which performs maintenance of the inkjet heads 44C, 44M, 44Y and 44K, and the inkjet heads 44C, 44M, 44Y and 44K are moved to the maintenance unit as and when necessary so as to be able to receive required maintenance.

### <Ink Drying Unit>

The ink drying unit 50 dries the liquid component remaining on the sheet of paper P after the image recording. The ink drying unit 50 includes: a conveyance drum (hereinafter referred to as the “ink drying drum”) 51, which conveys the sheet of paper P; and an ink drying device 52, which carries out the drying process on the sheet of paper P conveyed by the ink drying drum 51.

The ink drying drum 51 receives the sheet of paper P from the transfer drum 90 (by gripping the leading end of the sheet of paper P with the gripper), and conveys the sheet of paper P along a prescribed conveyance path by rotating.

The ink drying device 52 is constituted of a drier (in the present embodiment, three driers disposed along the conveyance path of the sheet of paper P) for example, and blows a warm air flow (at 80° C., for example) toward the sheet of paper P which is conveyed by the ink drying drum 51.

In the ink drying unit 50 having the composition described above, the sheet of paper P is conveyed along the prescribed conveyance path by the ink drying drum 51. During this conveyance process, a warm air flow is blown from the ink drying device 52 onto the printing surface of the sheet of paper P, and the ink that has been deposited on the printing surface is dried (i.e., the solvent component of the ink is evaporated).

The sheet of paper P which has passed through the ink drying device 52 is then transferred from the ink drying drum 51 onto the transfer drum 100 at a prescribed position. Thereupon, the sheet of paper P is conveyed along the prescribed conveyance path by the transfer drum 100 and is transferred onto the conveyance drum 61 of the fixing unit 60.

As described above, the drier 104 is disposed inside the transfer drum 100 and blows a warm air flow toward the guide plate 102. The sheet of paper P thereby undergoes a drying process during the conveyance by the transfer drum 100.

### <Fixing Unit>

The fixing unit 60 fixes the image that has been recorded on the printing surface of the sheet of paper P, by applying heat and pressure to the sheet of paper P. The fixing unit 60 includes: a conveyance drum (hereinafter referred to as the “fixing drum”) 61, which conveys the sheet of paper P; an ultraviolet light source 62, which applies ultraviolet light onto the printing surface of the sheet of paper P; and an in-line sensor 64, which captures a printed image as well as determining a temperature and humidity, and the like, of the sheet of paper P after the printing.

The fixing drum 61 receives the sheet of paper P from the transfer drum 100 (by gripping the leading end of the sheet of paper P with the gripper), and conveys the sheet of paper P along a prescribed conveyance path by rotating. During this conveyance, the ultraviolet light source 62 applies ultraviolet light to the printing surface of the sheet of the paper P, on which the aggregate of the treatment liquid and the ink is thereby irradiated with ultraviolet light and solidified.

The in-line sensor 64 includes a temperature meter, a humidity meter, and a CCD line sensor, and the like, and determines the temperature and humidity, and the like, of the sheet of paper P conveyed by the fixing drum 61, as well as reading the image printed on the sheet of paper P. Abnormalities of the inkjet recording apparatus 10 and head ejection defects, and the like, are checked on the basis of the determination results of the in-line sensor 64.

In the fixing unit 60 having the composition described above, the sheet of paper P is conveyed along the prescribed conveyance path by the fixing drum 61. During this conveyance process, the printing surface of the sheet of paper P is irradiated with ultraviolet light by the ultraviolet light source 62, and the aggregate of the treatment liquid and the ink is solidified.

The sheet of paper P which has undergone the fixing process is transferred from the fixing drum 61 to the recovery unit 70 at a prescribed position.

### <Recovery Unit>

The recovery unit 70 recovers the sheets of paper P which have undergone the series of printing processes, in a stacked fashion in a stacker 71. The recovery unit 70 includes: the stacker 71, which recovers the sheets of paper P; and a paper output conveyor 72, which receives the sheet of paper P that has undergone the fixing process in the fixing unit 60 from the fixing drum 61, conveys the sheet of paper P along a prescribed conveyance path, and outputs the sheet of paper P to the stacker 71.

The sheet of paper P that has undergone the fixing process in the fixing unit 60 is transferred from the fixing drum 61 onto the paper output conveyor 72, conveyed by the paper output conveyor 72 to the stacker 71, and then recovered in the stacker 71.

### Control System

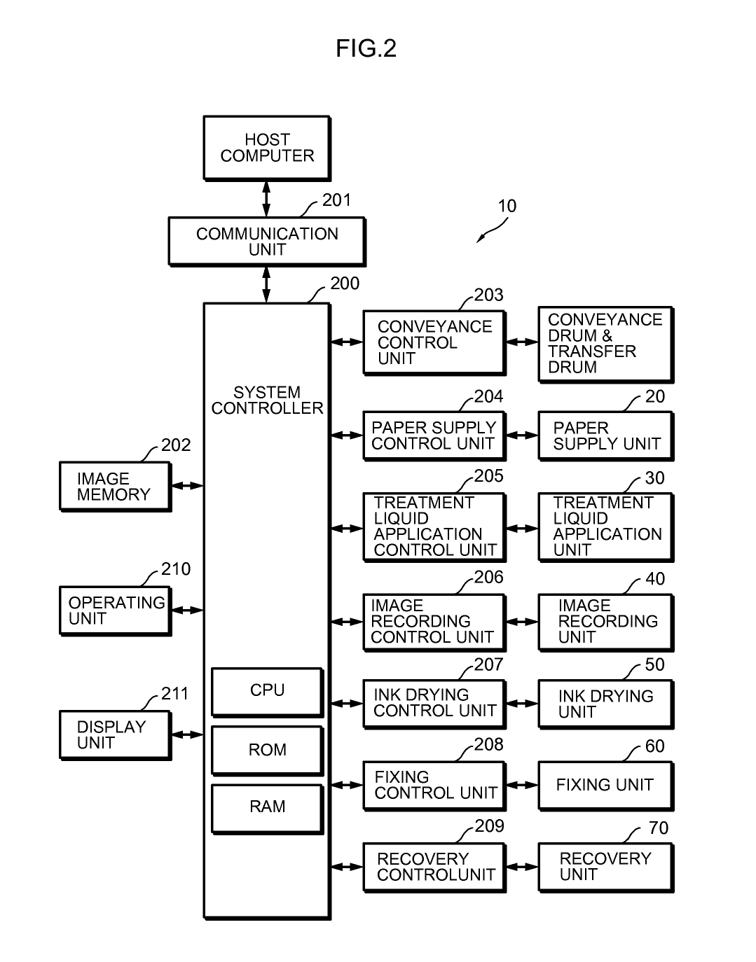

FIG. 2 is a block diagram showing the schematic composition of a control system of the inkjet recording apparatus 10 according to the present embodiment.

As shown in FIG. 2, the inkjet recording apparatus 10 includes a system controller 200, a communication unit 201, an image memory 202, a conveyance control unit 203, a paper supply control unit 204, a treatment liquid application control unit 205, an image recording control unit 206, an ink drying control unit 207, a fixing control unit 208, a recovery control unit 209, an operating unit 210, a display unit 211, and the like.

The system controller 200 functions as a control device which performs overall control of the respective units of the inkjet recording apparatus 10, and also functions as a calculation device which performs various calculation processes. The system controller 200 includes a CPU, ROM, RAM, and the like, and operates in accordance with a prescribed control program. Control programs executed by the system controller 200 and various data necessary for control purposes are stored in the ROM.

The communication unit 201 includes a prescribed communication interface, and sends and receives data between the communication interface and a connected host computer.

The image memory 202 functions as a temporary storage device for various data including image data, and data is read from and written to the memory through the system controller 200. Image data which has been read in from the host computer through the communication unit 201 is stored in the image memory 202.

The conveyance control unit 203 controls the driving of the conveyance drums 31, 41, 51 and 61 and the transfer drums 80, 90 and 100, which are the conveyance devices of the sheets of paper P in the treatment liquid application unit 30, the image recording unit 40, the ink drying unit 50 and the fixing unit 60.

More specifically, the conveyance control unit 203 controls the driving of the motors which drive the conveyance drums 31, 41, 51 and 61, and also controls the opening and closing of the grippers which are disposed on the conveyance drums 31, 41, 51 and 61.

Similarly, the conveyance control unit 203 controls the driving of the motors which drive the transfer drums 80, 90 and 100, and also controls the opening and closing of the grippers which are disposed on the transfer drums 80, 90 and 100.

Further, since the conveyance drums 31, 41, 51 and 61 are provided with the mechanisms for holding the sheets of paper P by attraction on the circumferential surfaces thereof, then the conveyance control unit 203 also controls the driving of the attraction holding mechanisms (in the present embodiment, since the sheets of paper P are held by vacuum suction, then the conveyance control unit 203 controls the driving of vacuum pumps functioning as negative pressure generating devices).

Furthermore, since the transfer drums 80, 90 and 100 are provided with the driers 84, 94 and 104, then the conveyance control unit 203 also controls the driving (amount of heating, and air flow volume) of the driers 84, 94 and 104.

The driving of the conveyance drums 31, 41, 51 and 61 and the transfer drums 80, 90 and 100 is controlled in accordance with instructions from the system controller 200.

The paper supply control unit 204 controls the driving of the respective sections (the paper supply device 21, the transfer drum 23, and the like) which constitute the paper supply unit 20, in accordance with instructions from the system controller 200.

The treatment liquid application control unit 205 controls the driving of the respective sections (the coating apparatus 32, and the like) which constitute the treatment liquid application unit 30, in accordance with instructions from the system controller 200.

The image recording control unit 206 controls the driving of the respective sections (the paper pressing roller 42, the inkjet heads 44C, 44M, 44Y and 44K, and the like) which constitute the image recording unit 40, in accordance with instructions from the system controller 200.

The ink drying control unit 207 controls the driving of the respective sections (the ink drying apparatus 52, and the like) which constitute the ink drying unit 50, in accordance with instructions from the system controller 200.

The fixing control unit 208 controls the driving of the respective sections (the ultraviolet light source 62, the in-line sensor 64, and the like) which constitute the fixing unit 60, in accordance with instructions from the system controller 200.

The recovery control unit 209 controls the driving of the respective sections (the paper output conveyer 72, and the like) which constitute the recovery unit 70, in accordance with instructions from the system controller 200.

The operating unit 210 includes prescribed operating devices (for example, operating buttons, a keyboard, a touch panel, or the like), and outputs operational information input from the operating device to the system controller 200. The system controller 200 executes various processing in accordance with the operational information input from the operating section 210.

The display unit 211 includes a prescribed display device (for example, an LCD panel, or the like), and causes prescribed information to be displayed on the display device in accordance with instructions from the system controller 200.

As described above, the image data to be recorded on the sheet of paper is read into the inkjet recording apparatus 10 from the host computer through the communication unit 201 and is stored in the image memory 202. The system controller 200 generates dot data by carrying out prescribed signal processing on the image data stored in the image memory 202, and records an image represented by the image data by controlling the driving of the inkjet heads of the image recording unit 40 in accordance with the generated dot data.

In general, the dot data is generated by subjecting the image data to color conversion processing and halftone processing. The color conversion processing is processing for converting image data represented by sRB, or the like (RB 8-bit image data, for example) into ink volume data for each color of ink used by the inkjet recording apparatus 10 (in the present embodiment, ink volume data for the respective colors of C, M, Y and K). The halftone processing is processing for converting the ink volume data of the respective colors generated by the color conversion processing into dot data of the respective colors by error diffusion processing, or the like.

The system controller 200 generates the dot data of the respective colors by applying the color conversion processing and the halftone processing to the image data. The image represented by the image data is recorded on the sheet of paper by controlling the driving of the corresponding inkjet heads in accordance with the dot data for the respective colors thus generated.

### Image Recording Process

Next, an image recording operation of the inkjet recording apparatus 10 according to the present embodiment is explained.

When the system controller 200 outputs a paper supply instruction to the paper supply device 21, a sheet of paper P is supplied from the paper supply device 21 to the paper supply tray 22. The sheet of paper P supplied to the paper supply tray 22 is transferred onto the treatment liquid application drum 31 of the treatment liquid application unit 30 through the transfer drum 23.

The sheet of paper P transferred on the treatment liquid application drum 31 is conveyed along the prescribed conveyance path by the treatment liquid application drum 31, and during this conveyance process, the treatment liquid is applied onto the printing surface of the sheet of paper P by the coating apparatus 32.

The sheet of paper P of which the printing surface has been coated with the treatment liquid is transferred from the treatment liquid application drum 31 onto the transfer drum 80. Thereupon, the sheet of paper P is conveyed along the prescribed conveyance path by the transfer drum 80 and is transferred onto the image recording drum 41 of the image recording unit 40. During the conveyance of the sheet of paper P by the transfer drum 80, the warm air flow is blown onto the printing surface of the sheet of paper P from the drier 84 disposed inside the transfer drum 80, and the treatment liquid that has been applied to the printing surface is dried.

The sheet of paper P transferred from the transfer drum 80 to the image recording drum 41 is firstly nipped by the paper pressing roller 42 and the rear surface of the sheet of paper P is caused to make tight contact with the outer circumferential surface of the image recording drum 41.

The presence or absence of floating in the sheet of paper P that has passed the paper pressing roller 42 is then determined by the paper floating detection sensor 43. If floating of the sheet of paper P is detected, the conveyance of the sheet of paper P is halted. On the other hand, if no floating is detected, then the sheet of paper P is continued to be conveyed to the inkjet heads 44C, 44M, 44Y and 44K. Thereupon, when the sheet of paper P passes below the inkjet heads 44C, 44M, 44Y and 44K, ink droplets of the respective colors of C, M, Y and K are ejected and deposited onto the printing surface of the sheet of paper P by the inkjet heads 44C, 44M, 44Y and 44K, and a color image is thereby formed on the printing surface.

The sheet of paper P on which the image has been formed is transferred from the image recording drum 41 onto the transfer drum 90. Thereupon, the sheet of paper P is conveyed along the prescribed conveyance path by the transfer drum 90 and is transferred onto the ink drying drum 51 of the image drying unit 50. During the conveyance of the sheet of paper P by the transfer drum 90, the warm air flow is blown onto the printing surface of the sheet of paper P from the drier 94 disposed inside the transfer drum 90, and the ink that has been deposited on the printing surface is dried.

The sheet of paper P transferred to the ink drying drum 51 is conveyed along the prescribed conveyance path by the ink drying drum 51. During this conveyance, the warm air flow is blown from the ink drying apparatus 52 onto the printing surface of the sheet of paper P and the liquid component remaining on the printing surface is dried.

The sheet of paper P that has undergone the drying process is transferred from the ink drying drum 51 onto the transfer drum 100. The sheet of paper P is conveyed on the prescribed conveyance path by the transfer drum 100 and is transferred onto the fixing drum 61 of the fixing unit 60. During the conveyance of the sheet of paper P by the transfer drum 100, the warm air flow is blown onto the printing surface of the sheet of paper P from the drier 104 disposed inside the transfer drum 100, and the ink that has been deposited on the printing surface is dried further.

The sheet of paper P transferred to the fixing drum 61 is conveyed along the prescribed conveyance path by the fixing drum 61. During this conveyance, the printing surface of the sheet of paper P is irradiated with ultraviolet light, and the image formed on the printing surface is fixed. The sheet of paper P is then transferred from the fixing drum 61 onto the paper output conveyor 72 of the recovery unit 70, conveyed by the paper output conveyor 72 to the stacker 71, and then output to the stacker 71.

As described above, in the inkjet recording apparatus 10 according to the present embodiment, the sheet of paper P is conveyed on the drums and during the course of conveyance, the respective processes of the application and drying of the treatment liquid, the deposition and drying of the ink droplets, and the fixing, are carried out on the sheet of paper P, thereby recording the prescribed image on the sheet of paper P.

### Coating Apparatus

Next, the coating apparatus 32, which is incorporated in the inkjet recording apparatus 10 according to the present embodiment, is described.

### <Basic Composition of Coating Apparatus>

Firstly, the basic composition of the coating apparatus 32 is described.

As described above, the coating apparatus 32 applies the treatment liquid (i.e., a coating liquid) to the surface (i.e., a surface to be coated) of the sheet of paper (i.e., an object to be coated) P, which is conveyed by the treatment liquid application drum (i.e., a conveyance device of the object to be coated) 31.

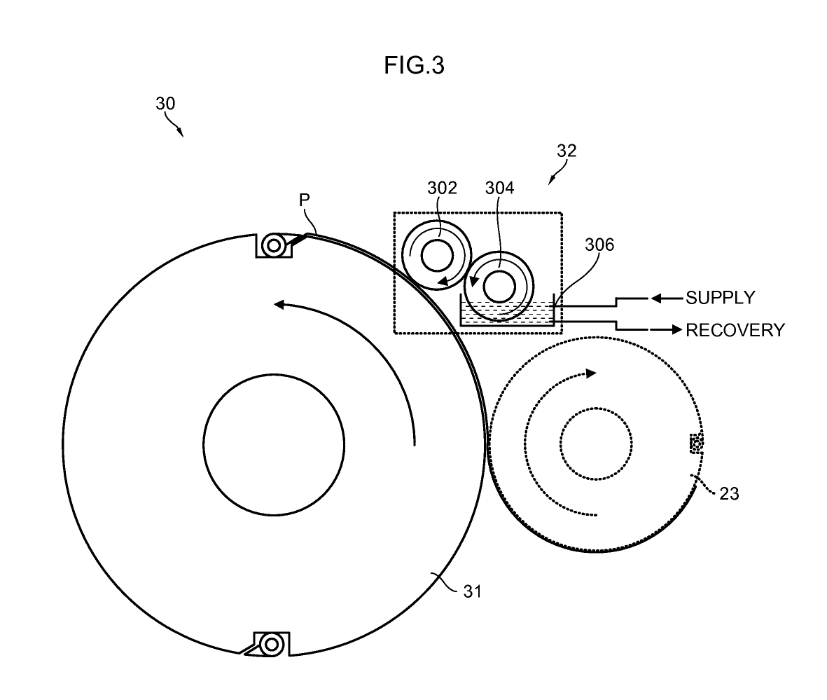

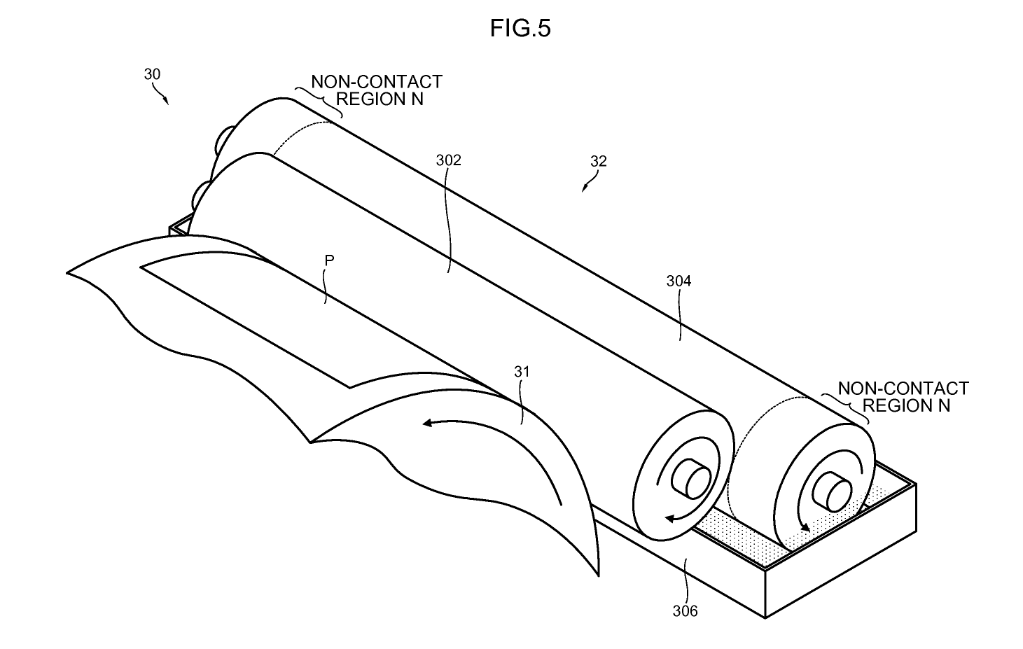

FIGS. 3, 4 and 5 are a side view diagram, a plan diagram and a perspective diagram, respectively, showing the schematic composition of the coating apparatus 32.

As shown in FIGS. 3 to 5, the coating apparatus 32 includes: a coating roller 302, which is configured to abut on the surface of the sheet of paper P to apply the treatment liquid to the surface of the sheet of paper P; a supply roller 304, which is configured to supply the treatment liquid to the circumferential surface of the coating roller 302; and a treatment liquid receptacle (i.e., a coating liquid supply device) 306, which supplies the treatment liquid to the circumferential surface of the supply roller 304. The coating apparatus 32 is disposed in the conveyance path of the sheet of paper P that is conveyed by the treatment liquid application drum 31.

The coating roller 302 applies the treatment liquid to the surface of the sheet of paper P, by making the circumferential surface thereof in contact with and pressed against the surface of the sheet of paper P, which is conveyed by the treatment liquid application drum 31.

The coating roller 302 has the circumferential surface of which a width (the dimension in the axial direction of the coating roller 302) is larger than a width (the dimension in the axial direction of the treatment liquid application drum 31) of the circumferential surface of the treatment liquid application drum 31. The coating roller 302 is disposed in parallel with the treatment liquid application drum 31, while axle portions at both ends of the coating roller 302 are rotatably supported by a coating roller supporting arm (not shown). The coating roller 302 is disposed in such a manner that the center of the circumferential surface thereof in the widthwise direction substantially coincides with the center of the circumferential surface of the treatment liquid application drum 31 in the widthwise direction.

The coating roller supporting arm is arranged on a coating apparatus main body frame (not shown). The coating roller supporting arm is arranged swingably about the position of the axis of rotation of the supply roller 304 when the supply roller 302 is situated in a prescribed supply position (described later).

A coating roller supporting arm swinging device (for example, a cylinder, or the like) which causes the coating roller supporting arm to swing is arranged on the coating apparatus main body frame. The coating roller supporting arm is caused to swing and move between a coating roller abutting position and a coating roller separating position, by the coating roller supporting arm swinging device. The coating roller 302 moves to a prescribed application position due to the coating roller supporting arm moving to the coating roller abutting position. Furthermore, by moving the coating roller supporting arm to the coating roller separating position, the coating roller 302 is moved to a prescribed withdrawn position. When the coating roller 302 moves to the application position, the circumferential surface of the coating roller 302 is in contact with and pressed against the circumferential surface of the treatment liquid application drum 31. When the coating roller 302 moves to the withdrawn position, the circumferential surface of the coating roller 302 is separated from the circumferential surface of the treatment liquid application drum 31.

A coating roller rotation drive device (for example, a motor) (not shown) is arranged on the coating roller supporting arm in order to rotate the coating roller 302. The coating roller 302 is rotated at a prescribed speed of rotation due to being driven by the coating roller rotation drive device. The direction of rotation of the coating roller 302 is an opposite direction to the direction of rotation of the treatment liquid application drum 31.

The supply roller 304 supplies the treatment liquid to the circumferential surface of the coating roller 302, by making the circumferential surface of the supply roller 304 in contact with the circumferential surface of the coating roller 302.

The supply roller 304 has the circumferential surface of which a width (the dimension in the axial direction of the supply roller 304) W1 is larger than the width (the dimension in the axial direction of the coating roller 302) W2 of the circumferential surface of the coating roller 302, so as to be able to supply the treatment liquid to the whole of the widthwise direction of the coating roller 302. The supply roller 304 is disposed in parallel with the coating roller 302, while axle portions at both ends of the supply roller 304 are rotatably supported by a supply roller supporting arm (not shown). The supply roller 304 is disposed in such a manner that the center of the circumferential surface thereof in the widthwise direction substantially coincides with the center of the circumferential surface of the supply roller 302 in the widthwise direction.

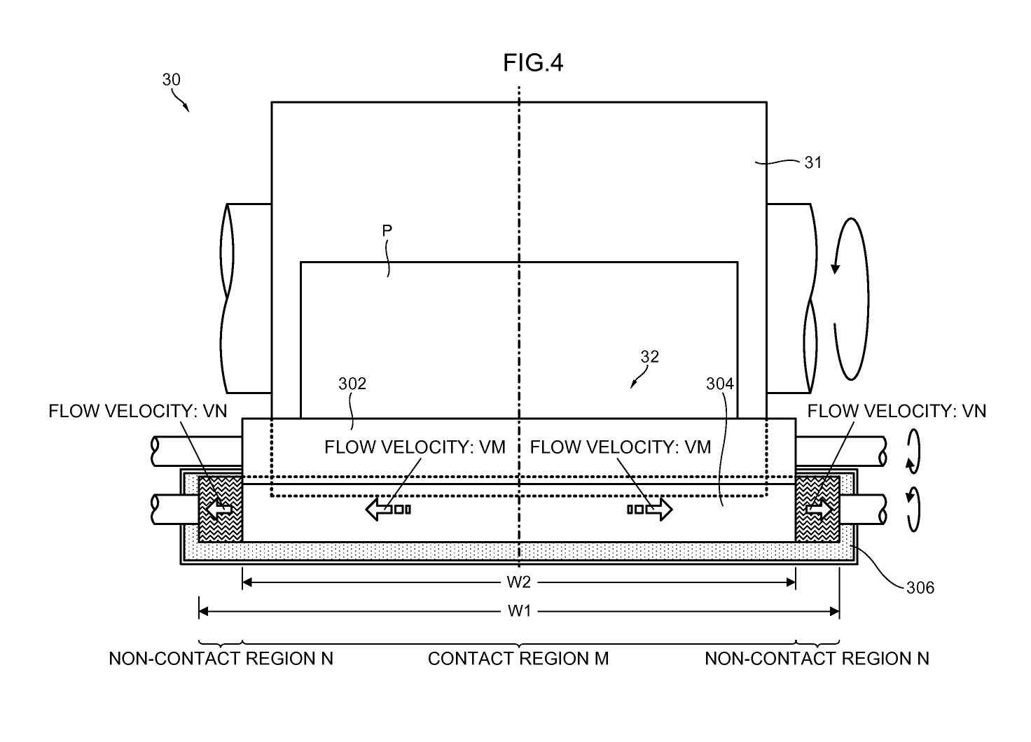

As described above, the supply roller 304 has the circumferential surface of which the width is larger than the width of the circumferential surface of the coating roller 302. Then, there are regions (non-contact regions) N which do not make contact with the circumferential surface of the coating roller 302 in both end portions of the circumferential surface of the supply roller 304 (in FIG. 4, the non-contact regions N are indicated by undulating lines at both ends of the supply roller 304). Each of the non-contact regions N has a surface state that is different from a surface state of a region (contact region) M which makes contact with the circumferential surface of the coating roller 302. More specifically, the non-contact regions N are formed so as to have increased wettability (hydrophilic properties) and the treatment liquid is more liable to flow thereon than in the contact region M. In this way, by making the treatment liquid more liable to flow in the non-contact regions N, it is possible to prevent ring-shaped collections of the treatment liquid due to the treatment liquid stagnating in both end portions of the coating roller 302. More specifically, it is possible to prevent the occurrence of ring-shaped collections of the treatment liquid in both end portions of the coating roller 302. This point is described in detail below.

The supply roller supporting arm is arranged on the coating apparatus main body frame. The supply roller supporting arm is arranged swingably about a swinging axis.

A supply roller supporting arm swinging device (for example, a cylinder, or the like) which causes the supply roller supporting arm to swing is arranged on the coating apparatus main body frame. The supply roller supporting arm is caused to swing and move between a supply roller abutting position and a supply roller separating position, by the supply roller supporting arm swinging device. The supply roller 304 moves to a prescribed supply position due to the supply roller supporting arm moving to the supply roller abutting position. Furthermore, by moving the supply roller supporting arm to the supply roller separating position, the supply roller 304 is moved to a prescribed supply halt position. When the supply roller 304 moves to the supply position, the circumferential surface of the supply roller 304 is in contact with and pressed against the circumferential surface of the coating roller 302. When the supply roller 304 moves to the supply halt position, the circumferential surface of the supply roller 304 is separated from the circumferential surface of the coating roller 302.

A supply roller rotation drive device (for example, a motor) (not shown) is arranged on the supply roller supporting arm in order to rotate the supply roller 304. The supply roller 304 is rotated at a prescribed speed of rotation due to being driven by the supply roller rotation drive device. The direction of rotation of the supply roller 304 is an opposite direction to the direction of rotation of the coating roller 302.

The treatment liquid receptacle 306 stores the treatment liquid and supplies the treatment liquid to the circumferential surface of the supply roller 304.

The treatment liquid receptacle 306 is formed in a dish shape having an open upper part. The treatment liquid receptacle 306 is arranged horizontally on the coating apparatus main body frame. The treatment liquid is stored in the treatment liquid receptacle 306. A part (lower part) of the supply roller 304 is immersed in the treatment liquid stored in the treatment liquid receptacle 306. By rotating the supply roller 304, the treatment liquid is taken up and is supplied to the circumferential surface of the coating roller 302, which abuts on the circumferential surface of the supply roller 304.

The treatment liquid is circulated and supplied to the treatment liquid receptacle 306 by a treatment liquid supply unit (not shown). The treatment liquid supply unit monitors a height of the surface of the treatment liquid stored in the treatment liquid receptacle 306, and circulates and supplies the treatment liquid so as to keep this height uniform.

The basic composition of the coating apparatus 32 is as described above.

### <Coating Operation>

Next, the basic operations of coating are described.

In an initial state, the coating roller 302 is situated at the standby position, and the supply roller 304 is situated in the separated position. Consequently, in the initial state, the coating roller 302 is separated from the treatment liquid application drum 31, and the supply roller 304 is separated from the coating roller 302.

Firstly, the coating roller 302 and the supply roller 304 are driven to rotate. By rotating the supply roller 304, the treatment liquid is supplied to the circumferential surface of the supply roller 304.

Next, the supply roller 304 is moved to the supply position. Thereby, the treatment liquid is supplied to the circumferential surface of the coating roller 302, due to the circumferential surface of the supply roller 304 abutting to the circumferential surface of the coating roller 302. In other words, due to the circumferential surface of the supply roller 304 abutting to the circumferential surface of the coating roller 302, the treatment liquid that has been deposited on the circumferential surface of the supply roller 304 is transferred onto the circumferential surface of the coating roller 302, whereby the treatment liquid is supplied to the circumferential surface of the coating roller 302. With this, the preparations for coating are completed. By moving the coating roller 302 to the application position in this state, it is possible to apply the treatment liquid to the surface of the sheet of paper P which is conveyed by the treatment liquid application drum 31.

Here, the movement of the coating roller 302 is controlled in synchronism with the conveyance of the sheet of paper P. More specifically, at the timing that the leading end of the sheet of paper P arrives at the position where the coating roller 302 is disposed, the coating roller 302 is controlled so as to move from the withdrawn position to the application position, and furthermore, at the timing that the trailing end of the sheet of paper P arrives at the position where the coating roller 302 is disposed, the coating roller 302 is controlled so as to move the coating roller 302 from the application position to the withdrawn position. Thus, the coating roller 302 is moved to the application position in synchronism with the timing at which the sheet of paper P passes, whereby the treatment liquid is applied to the surface of the sheet of paper P.

In this way, by moving the coating roller 302 which has received a supply of the treatment liquid on the circumferential surface thereof, in accordance with the conveyance of the sheets of paper P, the treatment liquid is applied to the surfaces of the sheets of paper P which are conveyed successively.

When the coating process has been completed, firstly, the rotations of the coating roller 302 and the supply roller 304 are halted in the state where the coating roller 302 is situated in the withdrawn position. Thereupon, the supply roller 304 is moved to the standby position. Thereby, the coating roller 302 is halted in the state of being separated from the treatment liquid application drum 31, and the supply roller 304 is halted in the state of being separated from the coating roller 302.

### <Detailed Structure of Coating Apparatus>

As described above, in the coating apparatus 32 according to the present embodiment, in order to be able to supply the treatment liquid to the whole region of the coating roller 302 in the widthwise direction, the width (the dimension in the axial direction) of the circumferential surface of the supply roller 304 is formed to be larger than the width (the dimension in the axial direction) of the circumferential surface of the coating roller 302. Hence, there are the regions (non-contact regions) N which do not make contact with the coating roller 302 in both end portions of the circumferential surface of the supply roller 304.

When the treatment liquid is supplied to the coating roller 302 by using the supply roller 304 having the circumferential surface of which the width is larger than the width of the circumferential surface of the coating roller 302 as described above, ring-shaped collections of the treatment liquid occur in both end portions of the coating roller 302. The reason for this is as follows. Surface tension acts on the treatment liquid so as to reduce the surface area thereof. In the region (contact region) where the coating roller 302 makes contact with the supply roller 304, there is a film of the treatment liquid and therefore a force causing the treatment liquid to flow in the axial direction due to the surface tension is obtained when the volume of the treatment liquid increases. On the other hand, in the non-contact region, the coating roller 302 is no longer present and therefore the force moving the treatment liquid in the axial direction does not exist. Hence, the flow of the treatment liquid (the flow in the axial direction) stagnates at the end portions of the coating roller 302 and ring-shaped collections of the treatment liquid are produced at the end portions of the coating roller 302. In this way, the ring-shaped collections of the treatment liquid that are produced in the end portions of the coating roller 302 occur due to the stagnation of the flow of the treatment liquid in the end portions of the coating roller 302.

Consequently, by preventing the stagnation of the flow of the treatment liquid in the end portions of the coating roller 302, it is possible to prevent the occurrence of ring-shaped collections of the treatment liquid in the end portions of the coating roller 302.

Therefore, in the coating apparatus 32 according to the present embodiment, the treatment liquid is prevented from forming ring-shaped collections at both end portions of the coating roller 302 by differentiating the surface state of the non-contact regions N so as to make the treatment liquid flow more readily on the non-contact regions N (flow more readily in the axial direction). This point is described in detail below.

### <Structure for Preventing Occurrence of Collections of Treatment Liquid>

As described above, by preventing the stagnation of the flow of the treatment liquid in the end portions of the coating roller 302, the occurrence of ring-shaped collections of the treatment liquid in the end portions of the coating roller 302 can be prevented. Therefore, the treatment liquid is made to flow more readily in the non-contact regions N of the supply roller 304. More specifically, the supply roller 304 is formed in such a manner that when the treatment liquid flows on the supply roller 304 alone, the flow velocity VN of the treatment liquid flowing on each of the non-contact regions N is faster than the flow velocity VM of the treatment liquid flowing on the contact region M (i.e., VN>VM), then it is possible to prevent the occurrence of ring-shaped collections of the treatment liquid in the end portions of the coating roller 302.

In order to make the flow velocity VN of the treatment liquid flowing on each of the non-contact regions N faster than the flow velocity VM of the treatment liquid flowing on the contact region M, the surface state of the non-contact regions N is differentiated so as to increase the wettability (hydrophilic properties). More specifically, provided that the wettability of the non-contact regions N is raised, it is possible to make the treatment liquid flow more readily in the non-contact regions N and the flow velocity VN of the treatment liquid flowing on each of the non-contact regions N can be made faster than the flow velocity VM of the treatment liquid flowing on the contact region M (i.e., VN>VM).

<Processing for Increasing the Wettability of the Non-Contact Regions>

In order to increase the wettability of the non-contact regions N, the supply roller 304 is formed in such a manner that the contact angle θN of the treatment liquid to the non-contact regions N is smaller than the contact angle θM of the treatment liquid to the contact region M (i.e., θN<θM).

It is possible to form the supply roller 304 in the following ways, in order to differentiate the contact angle θM of the treatment liquid from the contact region M and the contact angle θN of the treatment liquid to the non-contact regions N.

<<First Mode: Method Based on Changing Material>>

It is possible to differentiate the contact angle θM of the treatment liquid to the contact region M from the contact angle θN of the treatment liquid to the non-contact regions N, by differentiating the material used to compose the contact region M from the material used to compose the non-contact regions N.

For example, when the supply roller 304 is made of rubber, the contact region M is made from rubber having high hydrophobic properties (for example, fluoric rubber), and the non-contact regions N are made from rubber having high hydrophilic properties (for example, nitrile butadiene rubber (NBR)).

For example, when the supply roller 304 is made of metal, the contact region M is made from a metal having hydrophobic properties (for example, aluminum, stainless steel, or the like), and the non-contact regions N are made of a metal having hydrophilic properties (for example, titanium, or the like).

Thereby, it is possible to make the contact angle θN of the treatment liquid to the non-contact regions N smaller than the contact angle θM of the treatment liquid to the contact region M. In other words, it is possible to increase the hydrophilic properties of the non-contact regions N compared to the contact region M. Then, it is possible to make the treatment liquid flow more readily in the non-contact regions N, and stagnation of the flow of the treatment liquid can be prevented in the end portions of the coating roller 302. Consequently, it is possible to prevent the occurrence of ring-shaped collections of the treatment liquid in the end portions of the coating roller 302.

<<Second Mode: Method Based on Coating>>

By applying a coating treatment to the contact region M and/or the non-contact regions N, it is possible to differentiate the contact angle θM of the treatment liquid to the contact region M and the contact angle θN of the treatment liquid to the non-contact regions N.

For example, the contact region M is coated with a hydrophobic film of PTFE (polytetrafluoroethylene (tetrafluoride)), PFA (tetrafluoroethylene-perfluoroalkylvinylether copolymer polytetrafluoroethylene), or the like. Furthermore, the non-contact regions N are coated with a hydrophilic film of silica particles, or the like.

Thereby, it is possible to increase the hydrophilic properties of the non-contact regions N compared to the contact region M, and the treatment liquid can be made to flow more readily in the non-contact regions N. Then, it is possible to prevent stagnation of the flow of the treatment liquid in the end portions of the coating roller 302. Consequently, it is possible to prevent the occurrence of ring-shaped collections of the treatment liquid in the end portions of the coating roller 302.

Provided that the hydrophilic properties of the non-contact regions N can be increased, it is not necessarily required to apply the coating treatment to both the contact region M and the non-contact regions N. In other words, it is possible to apply the coating treatment to the non-contact regions N only, so as to increase the hydrophilic properties thereof compared to the contact region M.

<<Third Mode: Method Based on Changing Surface Roughness>>

By differentiating the surface roughness in the contact region M and in the non-contact regions N, it is possible to differentiate the contact angle θM of the treatment liquid to the contact region M and the contact angle θN of the treatment liquid to the non-contact regions N.

In other words, the value of the surface roughness of the non-contact regions N is made greater than the contact region M. More specifically, a process for roughening the surface is applied to the non-contact regions N.

Thereby, it is possible to make the contact angle θN of the treatment liquid to the non-contact regions N smaller than the contact angle θM of the treatment liquid to the contact region M. Then, it is possible to make the treatment liquid flow more readily in the non-contact regions N, and stagnation of the flow of the treatment liquid can be prevented in the end portions of the coating roller 302. Consequently, it is possible to prevent the occurrence of ring-shaped collections of the treatment liquid in the end portions of the coating roller 302.

As described above, by forming the supply roller 304 as to make the contact angle θN of the treatment liquid to the non-contact regions N smaller than the contact angle θM of the treatment liquid to the contact region M(θN<θM), it is possible to prevent stagnation of the flow of the treatment liquid in the end portions of the coating roller 302, whereby the occurrence of ring-shaped collections of the treatment liquid in the end portions of the coating roller 302 can be prevented.

In any of these modes, it is desirable that the contact angles (θM and θN) are not larger than 90°. If the contact angle is larger than 90°, then the treatment liquid becomes liable to pass around onto the end faces of the rollers, and the treatment liquid becomes liable to collect on the end faces of the rollers.

<Other Methods>

As described above, it is possible to prevent the occurrence of ring-shaped collections of the treatment liquid in the end portions of the coating roller 302, by making the treatment liquid flow more readily in the axial direction, in the non-contact regions N of the supply roller 304.

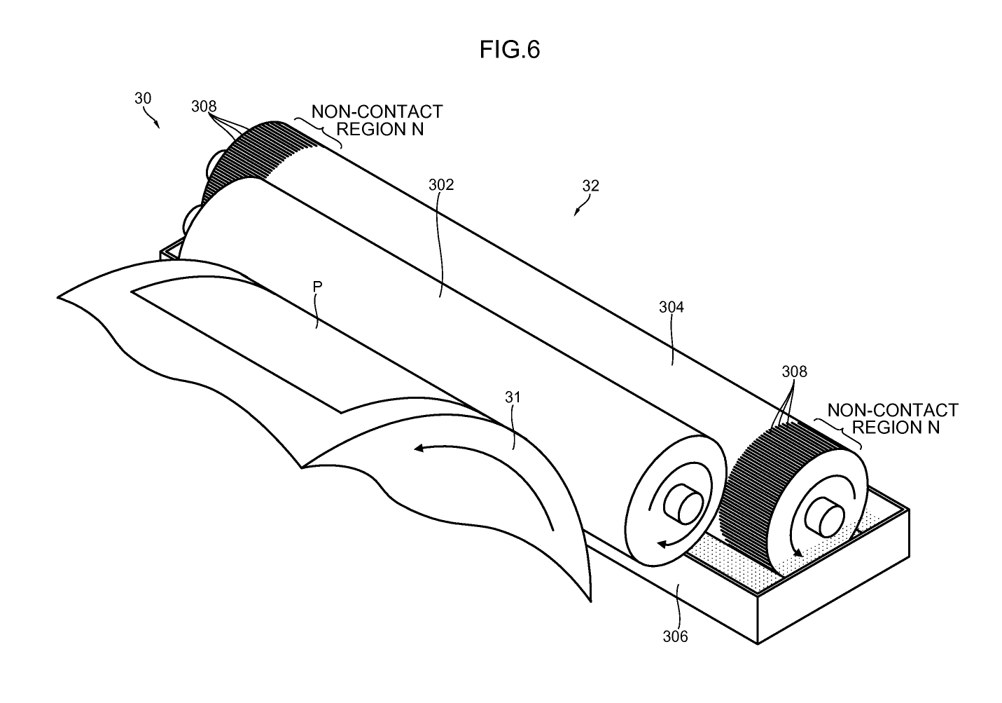

The treatment liquid can be made to flow more readily in the axial direction in the non-contact regions N, by forming linear grooves in the non-contact regions N. More specifically, as shown in FIG. 6, a plurality of grooves 308 parallel to the axis of the supply roller 304 are formed at a uniform pitch apart in the circumferential direction of the supply roller 304, in the non-contact regions N at both ends of the supply roller 304.

By forming the grooves 308 of this kind in the circumferential surface of the supply roller 304, a force acts so as to cause the treatment liquid to flow along the grooves 308 due to the action of the surface tension, and the treatment liquid can be made to flow more readily in the axial direction in the non-contact regions N (the flow velocity VN of the treatment liquid flowing on the non-contact regions N can be made faster than the flow velocity VM of the treatment liquid flowing on the contact region M). Consequently, it is possible to prevent the occurrence of ring-shaped collections of the treatment liquid at both ends of the coating roller 302.

It is preferable to form the plurality of fine grooves in the non-contact regions N, in order to be able to make the force causing the treatment liquid to flow in the axial direction act effectively on the treatment liquid due to the surface tension. More specifically, the contact surface area is secured by forming the plurality of fine grooves. For example, the grooves having the depth of 1 mm and the width of 0.5 mm are formed at intervals of 1 mm apart.

<Structure for Preventing Scattering of Treatment Liquid in Axial Direction>

As described above, according to the coating apparatus 32 of the present embodiment, the non-contact regions N at both ends of the supply roller 304 are composed in such a manner that the treatment liquid flows more readily in the axial direction. In this case, it is possible that the treatment liquid that has flowed to the end portions of the supply roller 304 adheres to the edges of the end faces of the supply roller 304 and scatters in the axial direction.

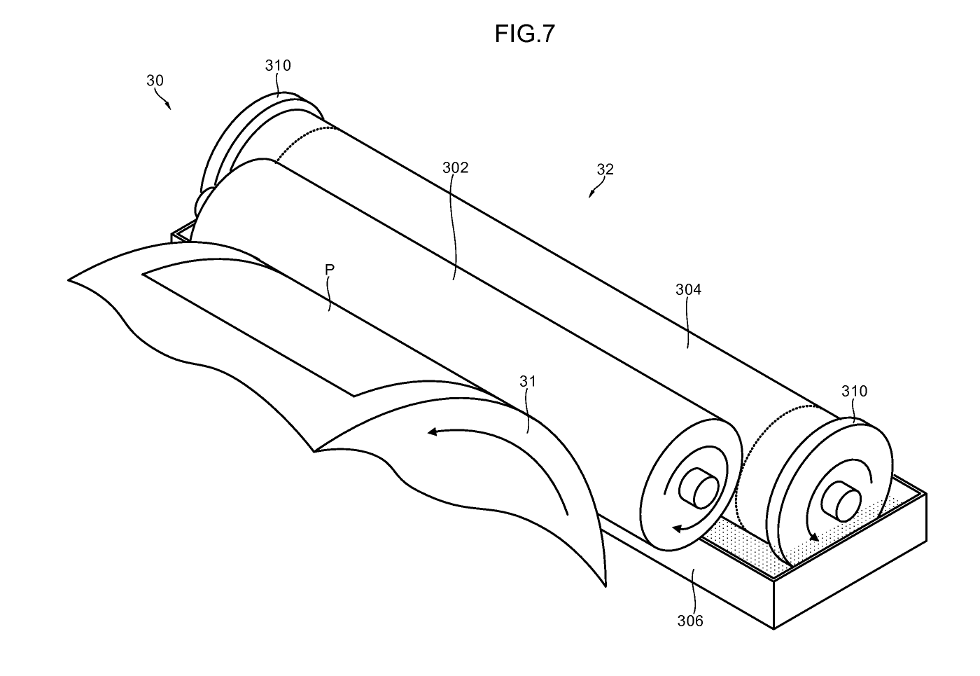

Therefore, in order to prevent this, as shown in FIG. 7, flange sections (portions having increased diameter) 310 are arranged at both end portions of the supply roller 304. In other words, a return portion is formed in each end portion of the supply roller 304.

Consequently, it is possible to prevent scattering, in the axial direction, of the treatment liquid that flows in the axial direction in the non-contact regions N.

### Other Embodiments

In the embodiment described above, there is one supply roller; however, it is also possible to adopt a composition in which the treatment liquid (i.e., the coating liquid) is supplied to the coating roller 302 by means of a plurality of supply rollers (so-called multi-stage supply rollers). In this case, a composition is adopted which satisfies the aforementioned relationship between the rollers.

More specifically, the supply rollers constituting the multi-stage supply rollers are formed in such a manner that, in each pair of the supply rollers, the width of the circumferential surface of a first one of the pair of the supply rollers at a preceding stage (the supply roller nearer to the treatment liquid receptacle) is larger than the width of the circumferential surface of a second one of the pair of the supply rollers at a subsequent stage (the supply roller nearer to the coating roller), and there are the regions which are not contact with the second supply roller at the subsequent stage in both end portions in the widthwise direction of the circumferential surface of the first supply roller at the preceding stage. Furthermore, the circumferential surface of a final one of the supply rollers at the final stage (the supply roller that abuts on the coating roller) is formed to have the width larger than the width of the circumferential surface of the coating roller, and there are the regions which do not make contact with the coating roller in both end portions in the widthwise direction of the circumferential surface of the supply roller at the final stage. Each of the supply rollers is formed by differentiating the surface state between the contact region and the non-contact regions, in such a manner that the flow velocity of the treatment liquid flowing on the non-contact regions is faster than the flow velocity of the treatment liquid flowing on the contact region.

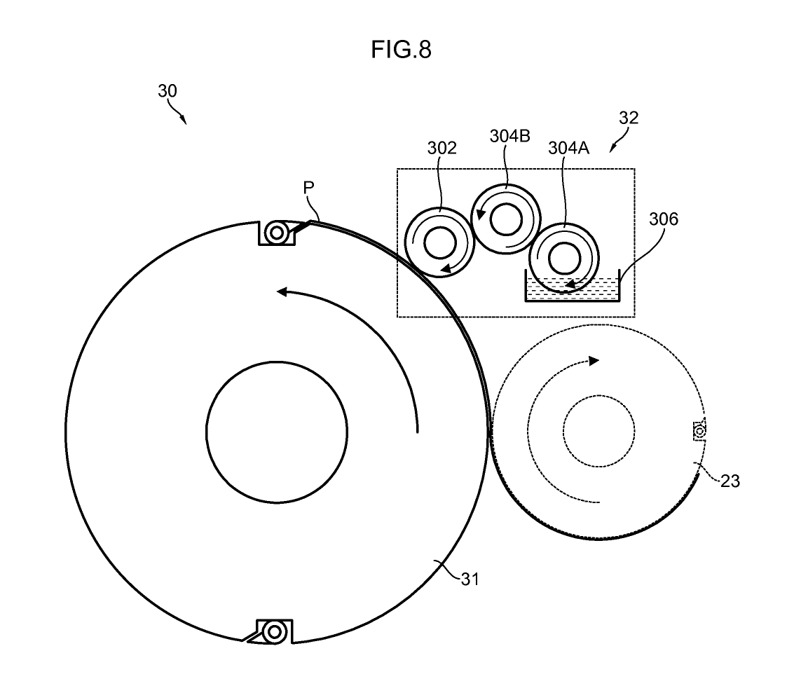

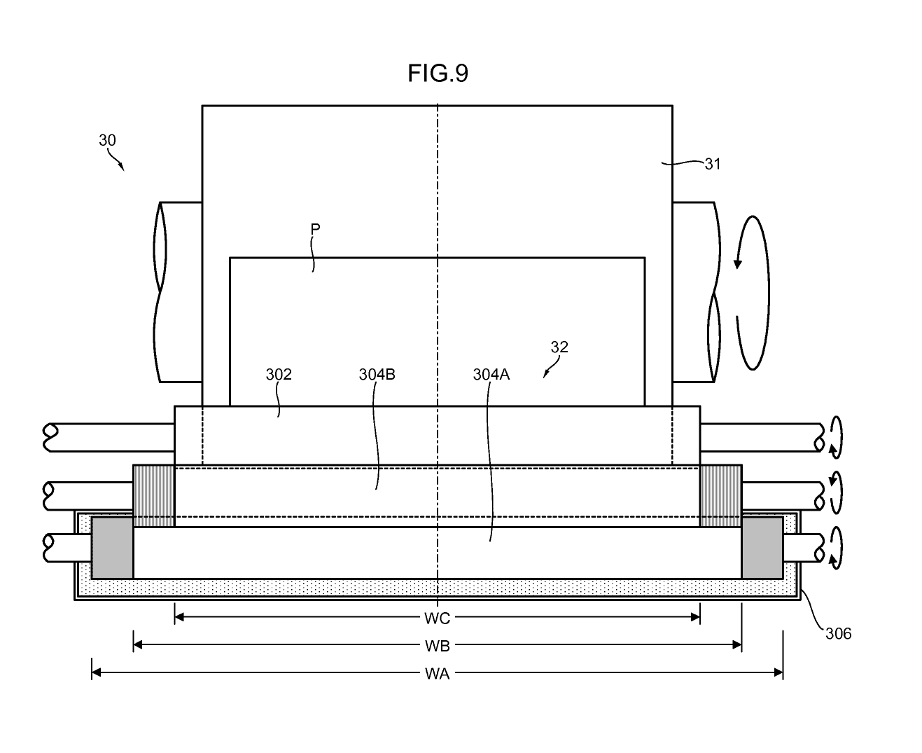

FIGS. 8 and 9 are a side view diagram and a plan diagram, respectively, showing a schematic composition of the coating apparatus of the type that supplies the treatment liquid to the coating roller through two supply rollers (two-stage supply rollers).

As shown in FIGS. 8 and 9, the coating apparatus 32 includes: the coating roller 302; a second supply roller 304B, which supplies the treatment liquid to the circumferential surface of the coating roller 302; a first supply roller 304A, which supplies the treatment liquid to the circumferential surface of the second supply roller 304B; and the treatment liquid receptacle 306, which supplies the treatment liquid to the circumferential surface of the first supply roller 304A.

The first supply roller 304A has the circumferential surface of which the width WA is larger than the width WB of the circumferential surface of the second supply roller 304B (i.e., WA>WB). Consequently, there are the regions (non-contact regions) which do not make contact with the second supply roller 304B in both end portions in the widthwise direction of the circumferential surface of the first supply roller 304A.

Furthermore, the second supply roller 304B has the circumferential surface of which the width WB is larger than the width WC of the circumferential surface of the coating roller 302 (i.e., WB>WC). Consequently, there are the regions (non-contact regions) which do not make contact with the coating roller 302 in both end portions in the widthwise direction of the circumferential surface of the second supply roller 304B.

Similarly to the embodiments described above, each of the supply rollers (the first supply roller 304A and the second supply roller 304B) is formed in such a manner that the flow velocity of the treatment liquid flowing on the non-contact regions is faster than the flow velocity of the treatment liquid flowing on the contact region. More specifically, the surface state of the non-contact regions is differentiated so as to increase the wettability (hydrophilic properties) and make the treatment liquid flow more readily in the non-contact regions.

Consequently, it is possible to prevent the occurrence of ring-shaped collections of the treatment liquid in both end portions of each roller.

In the embodiment described above, the supply rollers are constituted of the two rollers; however, it is also possible to compose multi-stage supply rollers using a greater number of supply rollers.

Furthermore, in the embodiments described above, the case where the present invention is applied to the coating apparatus for applying the prescribed treatment liquid to the paper in the inkjet recording apparatus has been described; however, the application of the present invention is not limited to this. It is also possible to apply the present invention in general to a coating apparatus which applies a coating liquid by means of rollers to an object to be coated.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A coating apparatus, comprising:
a coating roller which is configured to apply a coating liquid to an object to be coated;
a supply roller which is configured to abut on the coating roller and supply the coating liquid to the coating roller, wherein: the supply roller has a circumferential surface of which a width is larger than a width of a circumferential surface of the coating roller, the circumferential surface of the supply roller has a contact region configured to make contact with the coating roller and non-contact regions configured not to make contact with the coating roller, the non-contact regions are arranged respectively in both end portions of the circumferential surface of the supply roller in a widthwise direction thereof, the contact region has a surface state different from a surface state of each of the non-contact regions such that a flow velocity of the coating liquid flowing on each of the non-contact regions is faster than a flow velocity of the coating liquid flowing on the contact region; and
a coating liquid supply device which is configured to supply the coating liquid to the supply roller.

2. The coating apparatus as defined in claim 1, wherein the surface state of the contact region is different from the surface state of each of the non-contact regions such that a contact angle of the coating liquid to each of the non-contact regions is smaller than a contact angle of the coating liquid to the contact region.

3. The coating apparatus as defined in claim 2, wherein a material constituting the contact region is different from a material constituting each of the non-contact regions such that the contact angle of the coating liquid to each of the non-contact regions is smaller than the contact angle of the coating liquid to the contact region.

4. The coating apparatus as defined in claim 3, wherein the contact region is made from a hydrophobic material and each of the non-contact regions is made from a hydrophilic material.

5. The coating apparatus as defined in claim 2, wherein at least one of the contact region and each of the non-contact regions is coated with a thin film such that the contact angle of the coating liquid to each of the non-contact regions is smaller than the contact angle of the coating liquid to the contact region.

6. The coating apparatus as defined in claim 5, wherein the contact region is coated with a hydrophobic film and each of the non-contact regions are coated with a hydrophilic film.

7. The coating apparatus as defined in claim 2, wherein a surface roughness of the contact region is different from a surface roughness of each of the non-contact regions such that the contact angle of the coating liquid to each of the non-contact regions is smaller than the contact angle of the coating liquid to the contact region.

8. The coating apparatus as defined in claim 1, wherein each of the non-contact regions has grooves which are arranged in a uniform pitch in a circumferential direction of the supply roller and are parallel to an axis of the supply roller.

9. The coating apparatus as defined in claim 1, wherein the supply roller has flange sections in both ends thereof.

10. An inkjet recording apparatus, comprising:
the coating apparatus as defined in claim 1 which is configured to apply a prescribed coating liquid to a surface of paper; and
an inkjet head which is configured to form an image by ejecting and depositing ink droplets onto the surface of the paper that has been coated with the coating liquid.

11. A coating apparatus, comprising:
a coating roller which is configured to apply a coating liquid to an object to be coated;
multi-stage supply rollers which are arranged to sequentially abut to each other, wherein:
a final one of the supply rollers which is at a final stage of the multi-stage supply rollers is configured to abut on the coating roller and supply the coating liquid to the coating roller, the final one of the supply rollers has a circumferential surface of which a width is larger than a width of a circumferential surface of the coating roller, the circumferential surface of the final one of the supply rollers has a contact region configured to make contact with the coating roller and non-contact regions configured not to make contact with the coating roller, and the non-contact regions are arranged respectively in both end portions of the circumferential surface of the final one of the supply rollers in a widthwise direction thereof,
in each pair of the supply rollers constituted of a first one of the pair and a second one of the pair which abuts on the first one of the pair and is nearer to the coating roller than the first one of the pair, the first one of the pair has a circumferential surface of which a width is larger than a width of a circumferential surface of the second one of the pair, the circumferential surface of the first one of the pair has a contact region configured to make contact with the second one of the pair and non-contact regions configured not to make contact with the second one of the pair, and the non-contact regions are arranged respectively in both end portions of the circumferential surface of the first one of the pair in a widthwise direction thereof, and
in each of the supply rollers, the contact region has a surface state different from a surface state of each of the non-contact regions such that a flow velocity of the coating liquid flowing on each of the non-contact regions is faster than a flow velocity of the coating liquid flowing on the contact region; and
a coating liquid supply device which is configured to supply the coating liquid to an initial one of the supply rollers which is at an initial stage of the multi-stage supply rollers.

12. The coating apparatus as defined in claim 11, wherein the surface state of the contact region is different from the surface state of each of the non-contact regions such that a contact angle of the coating liquid to each of the non-contact regions is smaller than a contact angle of the coating liquid to the contact region.

13. The coating apparatus as defined in claim 12, wherein a material constituting the contact region is different from a material constituting each of the non-contact regions such that the contact angle of the coating liquid to each of the non-contact regions is smaller than the contact angle of the coating liquid to the contact region.

14. The coating apparatus as defined in claim 13, wherein the contact region is made from a hydrophobic material and each of the non-contact regions is made from a hydrophilic material.

15. The coating apparatus as defined in claim 12, wherein at least one of the contact region and each of the non-contact regions is coated with a thin film such that the contact angle of the coating liquid to each of the non-contact regions is smaller than the contact angle of the coating liquid to the contact region.

16. The coating apparatus as defined in claim 15, wherein the contact region is coated with a hydrophobic film and each of the non-contact regions are coated with a hydrophilic film.

17. The coating apparatus as defined in claim 12, wherein a surface roughness of the contact region is different from a surface roughness of each of the non-contact regions such that the contact angle of the coating liquid to each of the non-contact regions is smaller than the contact angle of the coating liquid to the contact region.

18. The coating apparatus as defined in claim 11, wherein each of the non-contact regions has grooves which are arranged in a uniform pitch in a circumferential direction of the supply roller and are parallel to an axis of the supply roller.

19. The coating apparatus as defined in claim 11, wherein the supply roller has flange sections in both ends thereof.

20. An inkjet recording apparatus, comprising:
the coating apparatus as defined in claim 11 which is configured to apply a prescribed coating liquid to a surface of paper; and
an inkjet head which is configured to form an image by ejecting and depositing ink droplets onto the surface of the paper that has been coated with the coating liquid.
